(19) United States
(12) Patent Application Publication
(10) Pub. No.: US 2024/0174355 A1
(43) Pub. Date: May 30, 2024

(54) NACELLE DEVICE AND VTOL AIRCRAFT

(71) Applicant: Rolls-Royce Deutschland Ltd & Co KG, Blankenfelde-Mahlow (DE)

(72) Inventor: Andreas FRÖDE, Neuenhagen (DE)

(21) Appl. No.: 18/521,655

(22) Filed: Nov. 28, 2023

(30) Foreign Application Priority Data
Nov. 30, 2022 (DE) 10 2022 131 791.9

(51) Int. Cl. B64C 29/00; B64C 7/02

(52) U.S. Cl. CPC B64C 29/0033; B64C 7/02

(57) ABSTRACT

Vertical take-off and landing (VTOL) aircraft and nacelle devices for VTOL aircraft are disclosed. The nacelle device is connected via a pylon device to a wing of the vertical take-off and landing aircraft and is pivotable relative to the pylon device by a pivoting device about an axis of rotation between a first position, (e.g., a propulsion position), and a second position, (e.g., a lift position). The axis of rotation is arranged within the pylon device and/or the nacelle device, in particular on an axial center plane of the pylon device.

The present patent document claims the benefit of German Patent Application No. 10 2022 131 791.9, filed Nov. 30, 2022, which is hereby incorporated by reference in its entirety.

### TECHNICAL FIELD

The disclosure relates to a nacelle device and to a vertical take-off and landing (VTOL) aircraft.

### BACKGROUND

Aircraft that may take-off and land vertically or vertical take-off and landing (VTOL) aircraft are known in principle. If an electric drive is used as the drive device of such an aircraft, the aircraft is also referred to as an eVTOL aircraft. Such aircraft are of considerable interest specifically for the use of aircraft in the urban sector (UAM: urban air mobility).

In principle, different designs are used, e.g., pure rotary wing aircraft or designs with pivotable wings or pivotable drives.

In a version with pivotable drives, the latter are moved from a lift position into a propulsion position, e.g., by pivotable nacelle devices (also referred to as nacelles). The nacelle devices are connected to a wing via a pylon device, with the pivoting about an axis taking place on the housing of the pylon device.

### SUMMARY AND DESCRIPTION

It is the object to provide improved nacelle devices that permit efficient flow guidance during the pivoting of the nacelle device.

The scope of the present disclosure is defined solely by the appended claims and is not affected to any degree by the statements within this summary. The present embodiments may obviate one or more of the drawbacks or limitations in the related art.

In this case, a nacelle device for a vertical take-off and landing aircraft is connected via a pylon device in a manner known per se to a wing of the vertical take-off and landing aircraft. The nacelle device is pivotable relative to the pylon device by a pivoting device about an axis of rotation between a first position, (e.g., a propulsion position), and a second position, (e.g., a lift position).

The axis of rotation is arranged within the pylon device and/or the nacelle device, wherein the axis of rotation may lie on or in an axial center plane of the pylon device.

By shifting of the axis of rotation into the interior, e.g., of the pylon device, the nacelle device may be pivoted spatially compactly. This also facilitates internal flow guidance.

The pivoting device may be part of the pylon device. For example, the pivoting device may be integrated within the pylon device. This may mean that parts of the wall of the pylon device are concomitantly pivoted.

Furthermore, the nacelle device is configured in such a manner that, when coupled to an air-guiding device inside the pylon device, air may flow continuously through the air-guiding device, specifically in the first position and in the second position of the nacelle device and also in positions in between. For a particularly efficient design, the interior of the pylon device is at least partially designed as the air-guiding device.

In one embodiment, the nacelle device may have at least one outlet opening, wherein the outlet opening has a first outlet region in the side wall and a second outlet region in the axial end region of the air-guiding device. Air may thus flow in different directions out of the nacelle device (or else may flow in, depending on the main flow direction). This arrangement of the outlet region makes it possible for air to be able to flow through the nacelle device and the pylon device in any pivoting position of the nacelle device.

It may be expedient for the at least one outlet opening with the outlet regions to be arranged axially in the region of the axis of rotation. In this case, the nacelle device pivots virtually around the outlet opening.

In a further embodiment, at least one air-conveying device, (e.g., a fan), may be arranged in the flow path of the air-guiding device, with the flow being able to be directed away from the drive unit or towards the drive unit.

The nacelle device may be coupled to at least one drive device, e.g., a rotor or a jet engine. The drive device may be configured electrically, e.g., as a transverse-flux machine.

The pivoting device may have a lever mechanism, (e.g., a hydraulically, electrically, or pneumatically driven lever mechanism). With these types of drive mechanisms, the nacelle device may be pivoted efficiently and safely.

The nacelle device, the pylon device, and/or the air-guiding device may have a circular, an elliptical, or a polygonal cross section at least in an axial section, for example. This allows different spatial requirements and flow conditions to be taken into account.

In a further embodiment, the nacelle device may be coupled via the pivoting device to a cover element, which, in the first position, covers and/or seals an open region between the nacelle device and the pylon device and which, upon pivoting into the second position, may be moved out of the region between the nacelle device and the pylon device. The cover element is thus used in the first position to delimit the interior of the nacelle device and the pylon device from the external space. In the event of pivoting, the cover element has to be pivoted out of this region so that, in the second position, the nacelle device and the pylon device fit together with their respective cross sections.

When the air guidance points away from the drive unit, least one exhaust-air opening for air from the one air-guiding device may be arranged on the pylon device. Furthermore, a flow-guiding device may be arranged under the wing. This makes it possible to direct the exhaust air in certain directions, e.g., vertically downwards to assist vertical flight.

In addition, the pylon device may be connected to a non-pivotable drive device.

### BRIEF DESCRIPTION OF THE DRAWINGS

The disclosure is explained in conjunction with the exemplary embodiments illustrated in the figures. In the figures:

FIG. 1A shows a schematic illustration of an embodiment of a nacelle device in a first position (propulsion position).

FIG. 1B shows the schematic illustration of the embodiment of the nacelle device according to FIG. 1A in a second position (lift position).

FIG. 2 and FIG. 2A show schematic illustrations of the air guidance in an embodiment of a nacelle device in a first position (propulsion position).

FIG. 3 shows a schematic illustration of the air guidance in the embodiment according to FIG. 3 in a second position (lift position).

FIG. 4 shows a schematic illustration of a first embodiment of the nacelle device on a vertical take-off and landing aircraft.

FIG. 5 shows a schematic illustration of a second embodiment of the nacelle device on a vertical take-off and landing aircraft.

FIG. 6A shows a side sectional view of a third embodiment of the nacelle device on a vertical take-off and landing aircraft in a first position (propulsion position).

FIG. 6B shows a side sectional view of the third embodiment of the nacelle device in an intermediate position.

FIG. 6C shows a side sectional view of the third embodiment of the nacelle device in a second position (lift position).

FIG. 7A shows a perspective view of the third embodiment of the nacelle device on a vertical take-off and landing aircraft in a first position (propulsion position).

FIG. 7B shows a perspective view of the third embodiment of the nacelle device in an intermediate position.

FIG. 7C shows a perspective view of the third embodiment of the nacelle device in a second position (lift position).

### DETAILED DESCRIPTION

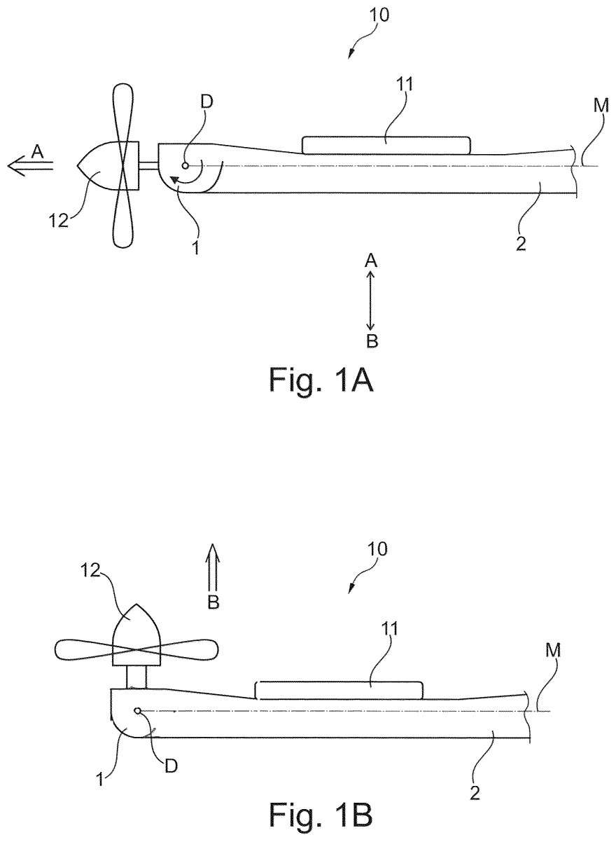

FIGS. 1A and 1B illustrate a schematic side view of a vertical take-off and landing aircraft 10 (also referred to as a vertical take-off aircraft). For reasons of clarity, only the wing 11 and the pylon device 2 arranged on the underside of the wing 11 are shown. The passenger cabin is therefore not shown here. In other embodiments not shown here, the pylon device 2 may also be arranged on the upper side of the wing 11.

The embodiment shown here is a vertical take-off and landing aircraft 10 in which a drive device 12, (e.g., a rotor or propeller), is pivotably coupled to a nacelle device 1.

For flight horizontally, (i.e., in a propulsion position), the rotor 12 is oriented on the front side of the pylon device 2 in such a manner that the rotor 12 moves air horizontally in the direction of the wing 11 during operation such that lift is generated. This is the first position A (propulsion position) of the drive device 12, which is illustrated in FIG. 1A. For conventional aircraft, this is the position in which take-off and landing are carried out, with extensive runways being required in each case.

To enable a vertical take-off and landing aircraft 10 to take off and land vertically, a drive device 12 that may also generate thrust vertically is required. The drive device 12 is located here on a nacelle device 1 (also called nacelle), which is designed as a housing that is movable relative to the pylon device 2.

In the embodiment illustrated in FIG. 1B, this is achieved by the fact that the drive device 12 is pivoted into a second position B (lift position) such that the air conveyed by the rotor generates a thrust downwards. The pivoting is performed here upwards relative to the pylon device 2 (clockwise in this case).

For take-off and landing, it is possible to switch between the two positions A and B, as indicated by the double arrow. This type of pivoting is known per se.

However, in the embodiment illustrated here, the axis of rotation D of the pivoting is arranged within the pylon device 2 and also within the nacelle device 1. The nacelle device 1 (and therefore the drive device 12) may thus be pivoted relative to the pylon device 2, with the pivoting not being carried out about an axis which lies in the outer wall of the nacelle device 1 or the wall of the pylon device 2.

By the arrangement of the axis of rotation D within the pylon device 2 or within the nacelle device 1, a spatially compact pivoting may be carried out to the effect that the nacelle device 1 (and thus the drive device 12) may be pivoted “within” the pylon device 2.

In the embodiment shown here, the axis of rotation D is arranged in the axial center plane M of the pylon device 2. Axially denotes here the longitudinal extent of the pylon device 2 in the flight direction. In other embodiments, the axis of rotation D may also be arranged above or below the axial center plane M, remaining within the housing of the pylon device 2 or the nacelle device 1.

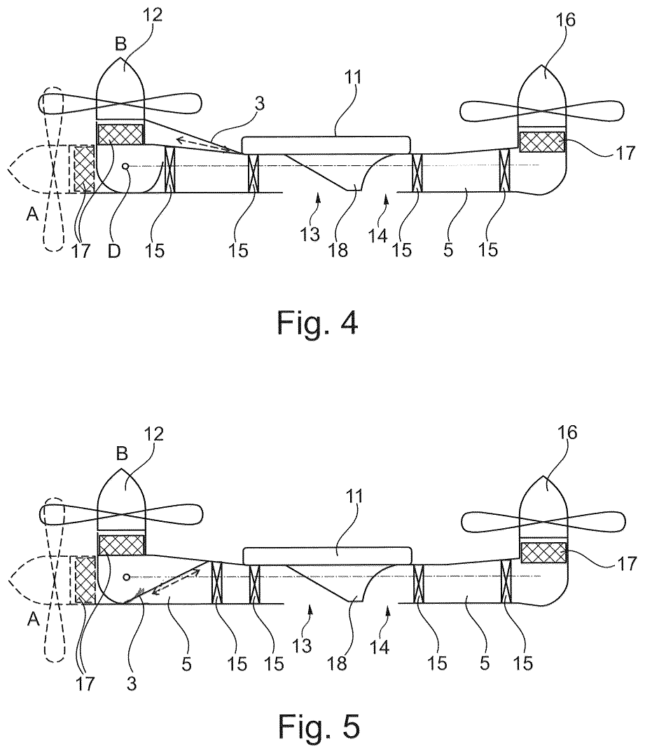

The pivoting device 3 with which the pivoting of the nacelle device 1 is brought about is not illustrated in FIGS. 1A and 1B for reasons of clarity. Embodiments of the pivoting device 3 are described in conjunction with FIGS. 4 and 5.

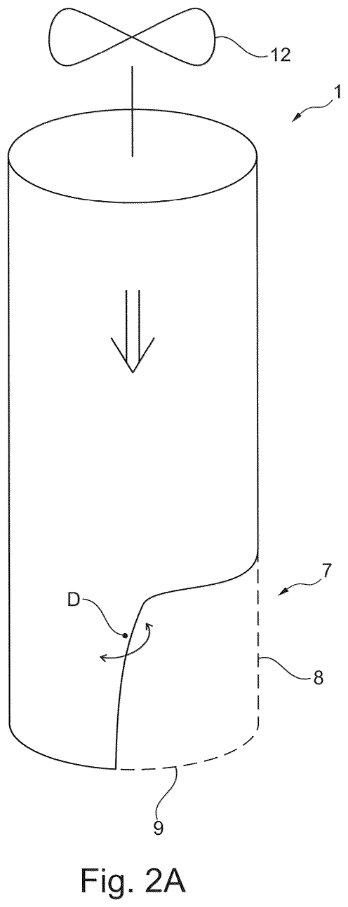

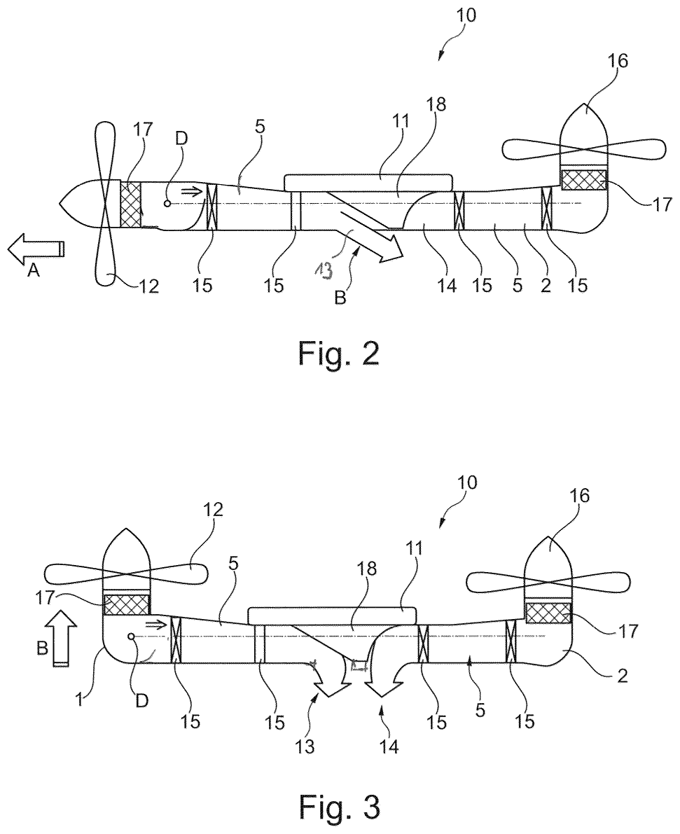

The effect which may furthermore be achieved by the axis of rotation D integrated in the pylon device 2 and a special configuration of the nacelle device 1 is particular air guidance in the interior of the pylon device 2, this being shown in FIGS. 2 and 3.

In other embodiments, the drive device 12 may also be configured as a jet engine, which is configured to be pivotable relative to the pylon device 2.

In principle, the two figures show the embodiment according to FIGS. 1A and 1B, and therefore reference may be made to the corresponding description.

FIGS. 2 and 3 each show a side view of a pylon device 2 having a nacelle device 1 that is arranged on the front side and (as described above) is pivotable. FIG. 2 illustrates the drive device 12 in the first position A (propulsion position). FIG. 3 illustrates the drive device 12 in the second position B (lift position).

FIGS. 2 and 3 describe the air guidance within the nacelle device 1 and the pylon device 2.

In particular, a portion of the air conveyed by the rotor 12 is conveyed into the interior of the nacelle device 2, illustrated in FIGS. 2 and 3 by the hatched area. The conveyed air flows through an air-guiding device 5, which is arranged inside the pylon device 2 or is formed by the housing of the pylon device 2 itself.

The nacelle device 1 has an outlet opening 7 in the axial rear part (with reference to the flow direction of the air), wherein the outlet opening 7 has a first outlet region 8 in the side wall and a second outlet region 9 in the axial end region of the air-guiding device 5.

This is illustrated schematically in FIG. 2A. The nacelle device 1 has a substantially circular-cylindrical shape, wherein the drive device 12 (here a rotor) is arranged on the axially front part.

Starting from the axially front part, air (indicated by a double arrow) flows through the interior of the nacelle device 1 in the direction of the outlet opening 7. The latter has two portions (outlet regions 8, 9), which are oriented differently.

The first outlet region 8 is a recess in the cylindrical side surface of the nacelle device 1, i.e., air may flow out radially here. The second outlet region 9 is a recess in the axial end surface of the nacelle device 1, i.e., air may flow out axially here.

This outlet opening 7 extending around the axial end makes it possible for air from the nacelle device 1 to be able to flow in each pivoting position from the nacelle device 1 into the air-guiding device 5 of the pylon device 2, this being illustrated for two positions in FIGS. 2 and 3.

In the propulsion position (FIG. 2), the nacelle device 1 is arranged horizontally, i.e., the side wall of the nacelle device 1 lies parallel to the wall of the pylon device 2. The air may thus flow via the second outlet region 9 of the outlet opening 7 (see FIG. 2A) into the air-guiding device 5 of the pylon device 2.

In the lift position (FIG. 3), the nacelle device 1 is arranged vertically, i.e., the side wall of the nacelle device 1 lies perpendicular to the wall of the pylon device 2. The air may thus flow via the first outlet region 8 of the outlet opening 7 (see FIG. 2A) into the air-guiding device 5 of the pylon device 2.

Even though only two (end) positions of the nacelle device 1 are illustrated here, it may be seen that the arrangement and shape of the outlet opening 7 makes it possible for air to flow through at least one of the outlet regions 8, 9 in each pivoting position of the nacelle device 1 between the first position A and the second position B. The axis of rotation D, about which the nacelle device 1 is pivotable, is also illustrated in FIG. 2; it lies axially in the region of the outlet opening 7, which is substantially movable about the axis of rotation D.

In other embodiments, the nacelle device 1 (and correspondingly the associated pylon device 2) may have other cross sections, such as elliptical or polygonal cross sections.

FIG. 2 shows that the air inside the pylon device 2 flows through the air-guiding device 5 to a first outlet opening 13, with the outflowing air in the event of propulsion being aligned such that the air flows substantially axially rearwards. In the event of lift (FIG. 3), the air is guided vertically downwards at the first outlet opening 14.

In the embodiment according to FIGS. 2 and 3, further features which may optionally be used individually and in combination are also included.

Thus, in the interior of the air-guiding device 5, an air-conveying device 15 is arranged in the form of fans that provide that air from the nacelle device 1 is effectively conveyed to the first outlet opening.

The rotor of the drive device 12 in the illustrated embodiment is also driven by an electric transverse-flux machine 17. Alternatively, it is also possible for other electric drives to be used.

The embodiment according to FIGS. 1A and 1B has only one drive device 12, which is arranged pivotably on the pylon device 2.

The embodiment according to FIGS. 2 and 3, on the other hand, has another non-pivotable drive device 16, which is arranged on the rear part of the pylon device 2. This drive device 16 is arranged in a fixed lift position, with the drive also being carried out here via a transverse-flux machine. In the event of propulsion (FIG. 2), this non-pivotable drive device 16 is not in operation.

In the event of lift (FIG. 3), when the non-pivotable drive device is in operation, air is conveyed here by an air-guiding device 5 inside the pylon device 2, namely to a second exhaust-air opening 14. The outflowing air is guided in such a way that it flows out substantially vertically, like the air from the first exhaust-air opening 13 in this case.

A flow-guiding device 18 is arranged between the two exhaust-air openings 13, 14, the flow-guiding device providing the alignment of the air flow in the vertical direction. The flow-guiding device 18 is arranged here below the wing 11.

The air flow from the non-pivotable drive device 16 is also assisted in the air-guiding device 5 by air-conveying device 15.

It is further noted that the flow direction from the drive device 12 through the air-guiding device 5 in this example (and also in the following examples) is not mandatory. Even if air flows in the other direction through the air-guiding device 5, because the air is sucked up, (e.g., by the drive unit 12), the same structure may be used. Even in this case, air may flow through the pylon device 2 and the pivotable nacelle device 1 in any position A, B.

FIG. 4 illustrates another embodiment of a pivotable nacelle device 1 (solid lines: position B; dashed lines: position A), which corresponds to the embodiment of FIGS. 2 and 3, and therefore reference may be made to the corresponding description. The air flow in the nacelle device 1 and the pylon device 2 (cf. FIGS. 2 and 3) is not illustrated here for reasons of clarity.

On the other hand, the pivoting device 3, which is designed as a lever mechanism (e.g., similarly to the lever mechanism of an aircraft landing gear), is shown. Only one lever which is located outside the housing of the pylon device 2 is shown here. The dashed double arrow indicates the direction in which the lever moves.

FIG. 5 shows a modification of the embodiment of FIG. 4, and therefore reference may be made to the corresponding description. In contrast to the embodiment illustrated here, the pivoting device 3 is designed as a lever mechanism in such a way that the lever arm engages inside the pylon device. The direction of movement of the lever is also shown here by a dashed double arrow.

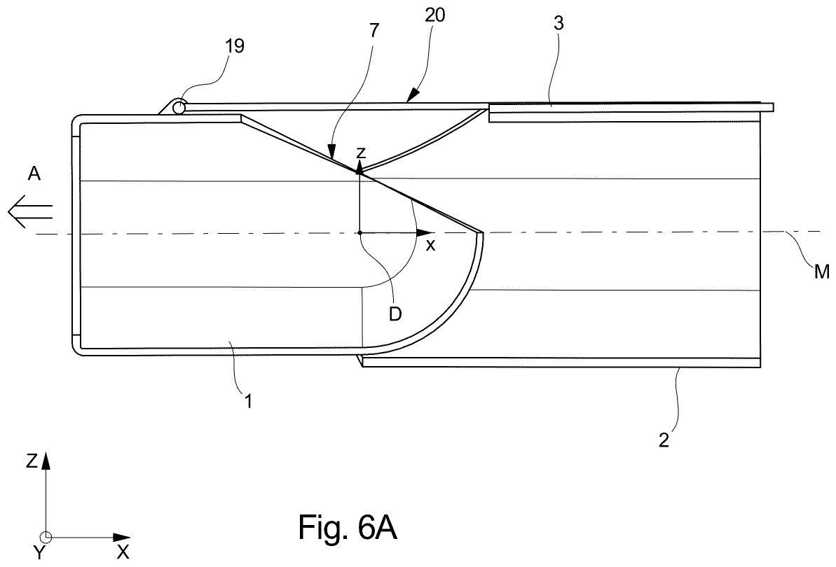

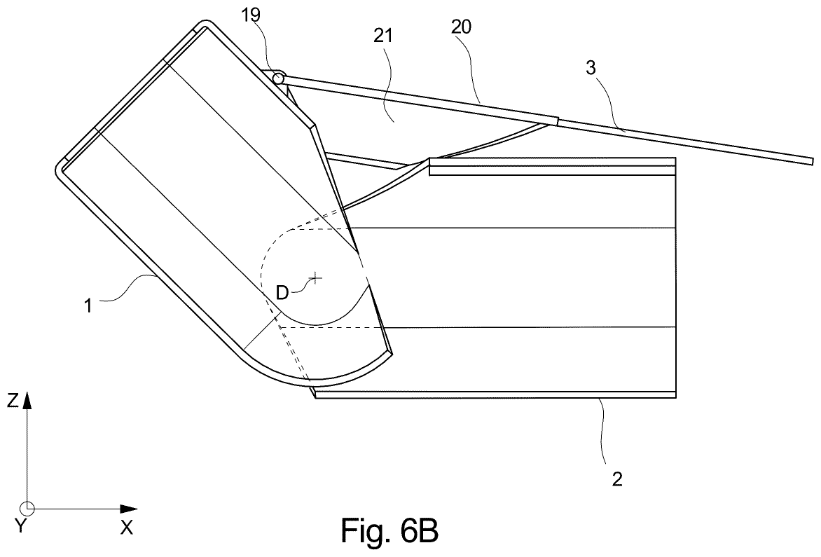

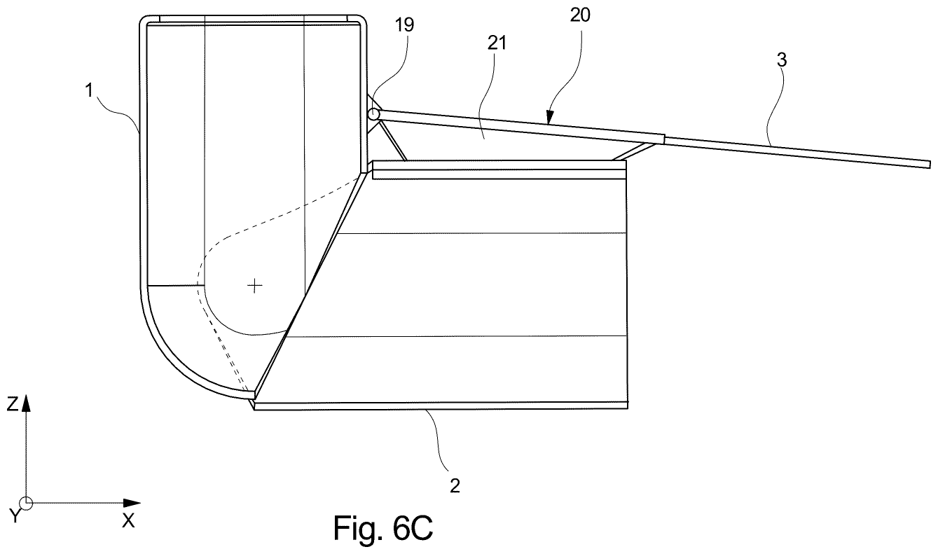

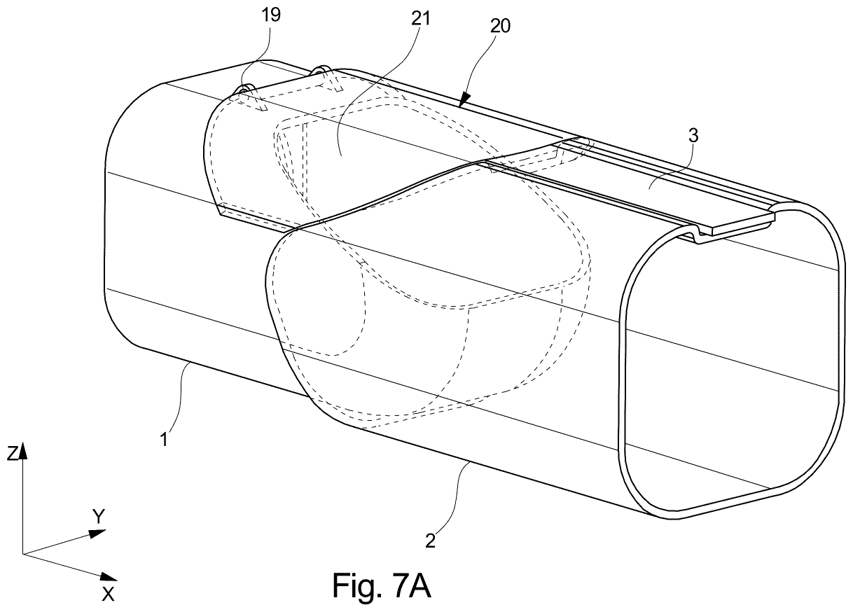

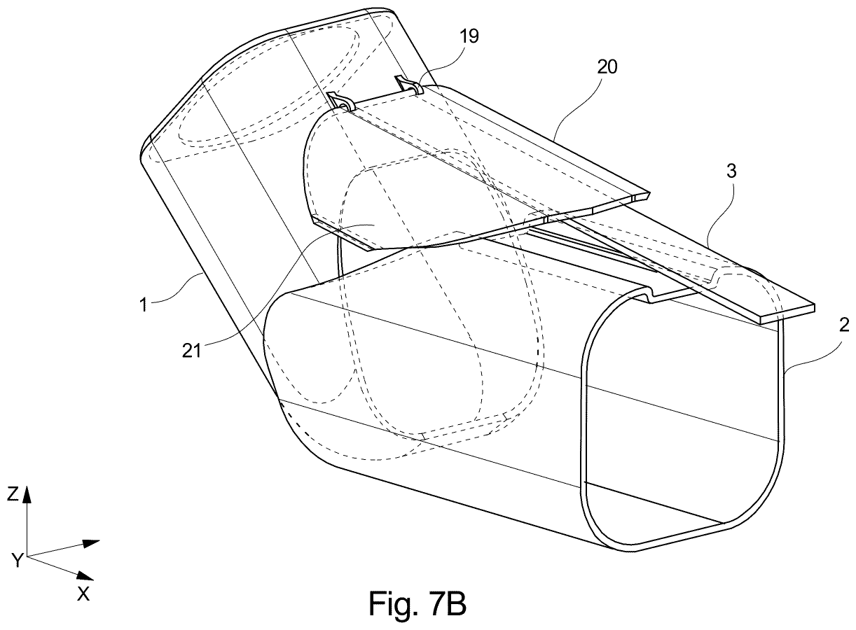

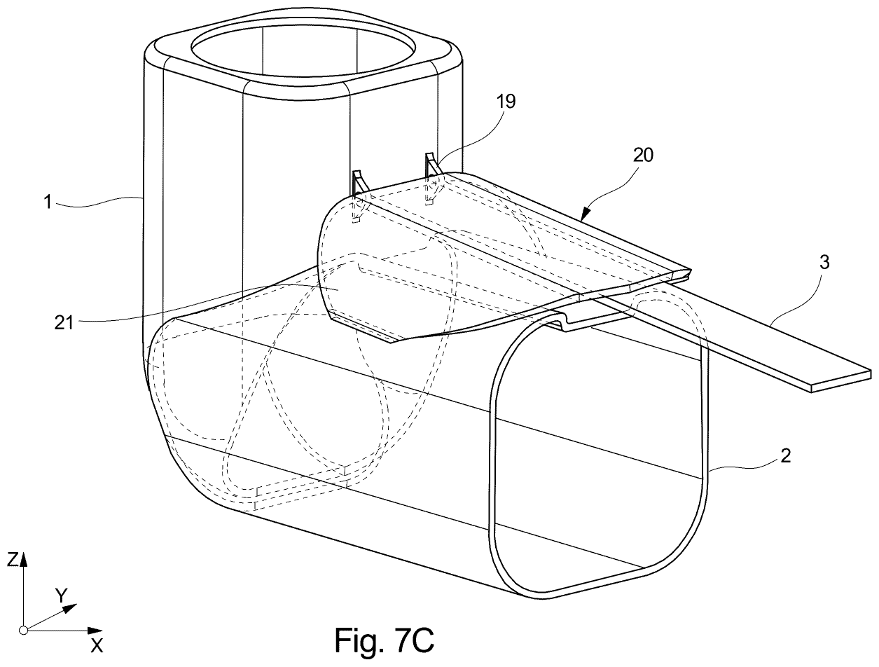

FIGS. 6A to 6C and 7A to 7C illustrate various views of a third embodiment, wherein the nacelle device 1, the pylon device 2, and the pivoting device 3 functionally correspond in principle to the embodiments illustrated above, and therefore reference may be made to the corresponding description.

However, the illustration in FIGS. 6A to 6C and 7A to 7C is simplified, because assemblies inside the nacelle device 1 and the pylon device 2, such as the drive device 12, are not illustrated here. FIGS. 6A to 6C and 7A to 7C are intended especially to show the geometry of the nacelle device 1 and an example of the pivoting device 3, which may also be transferred analogously to the embodiments already illustrated. FIGS. 6A to 6C each show a sectional view in different positions. FIGS. 7A to 7C each show a perspective view in the same positions as FIGS. 6A to 6C. In the illustration of FIGS. 7A to 7C, the components are depicted transparently in order to make the function clearer.

FIGS. 6A and 7A each illustrate the nacelle device 1 in the first position A, (i.e., the propulsion position), which is indicated by the double arrow. The nacelle device 1 and the pylon device 2 are arranged here one after the other. The free inner diameter of the pylon device 2 is slightly larger than the outer diameter of the nacelle device 1, and therefore the nacelle device 1 partially projects into the pylon device 2. It may be seen in FIG. 7A that the cross section of the nacelle device 1 and of the pylon device 2 is substantially square, with the corners each being rounded here. Other embodiments may also have rectangular, other polygonal or round cross sections.

The nacelle device 1 is designed to be pivotable relative to the pylon device 2, wherein, in the embodiment illustrated here, the axis of rotation D is located inside the nacelle device 1 on the axial center plane M (see FIG. 6A). As may be seen in FIG. 6A, the axis of rotation D is also located precisely on the left end surface of the pylon device 2. The nacelle device 1 is pivotable clockwise about the axis of rotation D.

The nacelle device 1 has an outlet opening 7 for the air-guiding device 5, not shown in detail here, in the interior of the nacelle device 1. This means that inflowing air from the nacelle device 1 may flow via the outlet opening 7 into the pylon device 2. The outlet opening 7 is designed here in such a way that the side wall of the nacelle device 1 and the axial wall of the nacelle device 1 are partially cut out. The section goes from the side wall as far as the axial center plane M. The section angle is approx. 30° in relation to the axial center plane M.

The axis of rotation D is arranged axially in the nacelle device 1 in such a way that it is located in the region of the outlet opening 7, here approximately in the axially rear half of the region of the outlet opening 7.

A lever element of the pivoting device 3 is shown on the upper side of the nacelle device 1 and of the pylon device 2. As may be seen in FIG. 7A, the lever element is formed here flat, but other embodiments, such as rod-shaped elements, are also conceivable. For reasons of clarity, a drive of the pivoting device 3 is not shown here.

The lever element of the pivoting device 3 is applied to the nacelle device via a rotary joint 19, the function of which during the pivoting will become clear below.

FIGS. 6B and 7B illustrate the nacelle device 1 in an intermediate position pivoted in relation to the pylon device 2. This is achieved by pulling the lever element of the pivoting device 3 axially rearwards (to the right in FIG. 6B). Thus, a torque is applied to the rotary joint 19, the torque pivoting the nacelle device 1 clockwise about the axis of rotation D.

FIGS. 6C and 7C illustrate the nacelle device 1 in the end position, (i.e., the second position for the lift position). The beveled outlet opening 7 of the nacelle device 1 corresponds in this position to the cross section of the pylon device 2, which is inclined at an angle of approx. 30°.

In principle, it is possible for sealing elements to be arranged at the edges of the outlet opening 7 and/or at the corresponding cross section of the pylon device 2, so that air flowing through the nacelle device 1 may flow without loss, or at least with little loss, into the pylon device 2.

In FIGS. 6B, 6C, 7A, 7B, and 7C, a cover element 20 coupled to the pivoting device 3 may also be seen. The cover element serves to seal the region between nacelle device 1 and pylon device 2 in the first end position (i.e., position A; positions in FIGS. 6A and 7A). The cover element 20 is trough-shaped with a bevel at the side regions 21, wherein the bevels correspond to the bevels of the pylon device 2 (see FIGS. 6A and 7A). The side regions 21 of the cover element 20 seal the transition region between nacelle device 1 and pylon device 2 laterally, as may clearly be seen in particular in FIG. 7A.

When pivoting the nacelle device 1 into the second end position (position B, see FIGS. 6C and 7C), the cover element 20 is raised and moved out of the region between nacelle device 1 and pylon device 2 and comes to lie in the second end position above the pylon device 2. The sealing between nacelle device 1 and pylon device 2 is then carried out on the oblique cross sections, as already described above.

It should be understood that the disclosure is not limited to the embodiments described above, and various modifications and improvements may be made without departing from the concepts described here. It is furthermore to be noted that any of the features described may be used separately or in combination with any other features, provided that they are not mutually exclusive. The disclosure extends to and includes all combinations and sub-combinations of one or more features that are described here. If ranges are defined, these ranges therefore include all the values within these ranges as well as all the partial ranges that lie within a range.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

### LIST OF REFERENCE SIGNS

1 nacelle device
2 pylon device
3 pivoting device
5 air-guiding device
7 outlet opening of air-guiding device
8 first outlet region
9 second outlet region
10 vertical take-off and landing aircraft
11 wing
12 drive device, rotor
13 first exhaust-air opening
14 second exhaust-air opening
15 air-conveying device, (e.g., fan)
16 non-pivotable drive device
17 transverse-flux machine
18 flow-guiding device
19 rotary joint
20 cover element
21 side region of the cover element
A first position of the drive device, propulsion position
B second position of the drive device, lift position
D axis of rotation of the drive device
M axial center plane of pylon device

1. A nacelle device for a vertical take-off and landing (VTOL) aircraft, the nacelle device comprising:
a pivoting device,
wherein the nacelle device is configured to be connected via a pylon device to a wing of the VTOL aircraft,
wherein the nacelle device is pivotable relative to the pylon device by the pivoting device about an axis of rotation between a first position and a second position,
wherein the first position is a propulsion position,
wherein the second position is a lift position, and
wherein the axis of rotation is arranged within the pylon device and/or the nacelle device.

2. The nacelle device of claim 1, wherein the axis of rotation is arranged on an axial center plane of the pylon device.

3. The nacelle device of claim 1, wherein the pivoting device is a part of the pylon device or is integrated within the pylon device.

4. The nacelle device of claim 1, further comprising:
an air-guiding device arranged inside the pylon device,
wherein air is configured flow continuously through the air-guiding device in the first position, in the second position, and in positions in between the first position and the second position.

5. The nacelle device of claim 4, wherein an inside of the pylon device is at least partially configured as the air-guiding device.

6. The nacelle device of claim 5, further comprising:
at least one air-conveying device arranged in a flow path of the air-guiding device.

7. The nacelle device of claim 6, wherein the at least one air-conveying device is at least one fan.

8. The nacelle device of claim 4, wherein the nacelle device, the pylon device, and/or the air-guiding device comprises a circular cross section, an elliptical cross section, or a polygonal cross section at least in an axial section.

9. The nacelle device of claim 1, further comprising:
at least one outlet opening,
wherein the at least one outlet opening has a first outlet region in a side wall and a second outlet region in an axial end region.

10. The nacelle device of claim 9, wherein the at least one outlet opening is arranged axially in a region of the axis of rotation.

11. The nacelle device of claim 1, further comprising:
a coupling to at least one drive device.

12. The nacelle device of claim 11, wherein the at least one drive device is a rotor or a jet engine.

13. The nacelle device of claim 11, wherein the at least one drive device is coupled to an electric drive or a transverse flux machine.

14. The nacelle device of claim 1, wherein the pivoting device has a lever mechanism.

15. The nacelle device of claim 14, wherein the lever mechanism is a hydraulically driven lever mechanism, an electrically driven lever mechanism, or a pneumatically driven lever mechanism.

16. The nacelle device of claim 1, further comprising:
a cover element,
wherein the nacelle device is coupled via the pivoting device to the cover element that, in the first position, covers and/or seals an open region between the nacelle device and the pylon device and which, upon pivoting into the second position, is configured to be moved out of a region between the nacelle device and the pylon device.

17. A vertical take-off and landing (VTOL) aircraft comprising:
at least one pylon device on a wing of the VTOL aircraft; and
at least one nacelle device having a pivoting device,
wherein the at least one nacelle device is connected via the at least one pylon device,
wherein the at least one nacelle device is pivotable relative to the at least one pylon device by the pivoting device about an axis of rotation between a first position and a second position,
wherein the first position is a propulsion position,
wherein the second position is a lift position, and
wherein the axis of rotation is arranged within the at least one pylon device and/or the at least one nacelle device.

18. The VTOL aircraft of claim 17, wherein the at least one nacelle device further comprises an air-guiding device arranged inside the at least one pylon device, and
wherein the VTOL aircraft further comprises at least one exhaust-air opening arranged on the at least one pylon device for conveying air from the air-guiding device.

19. The VTOL aircraft of claim 17, further comprising:
a flow-guiding device is arranged under the wing.

20. The VTOL aircraft of claim 17, further comprising:
a non-pivotable drive device,
wherein the at least one pylon device is connected to the non-pivotable drive device.
